(19) United States
(12) Patent Application Publication
(10) Pub. No.: US 2012/0255848 A1
(43) Pub. Date: Oct. 11, 2012

(54) TOUCH PANEL

(75) Inventors: Mitsuhiro Sekizawa, Tokyo (JP); Koichi Kondoh, Tokyo (JP)

(73) Assignee: FUJITSU COMPONENT LIMITED, Tokyo (JP)

(21) Appl. No.: 13/431,492

(22) Filed: Mar. 27, 2012

(30) Foreign Application Priority Data
Apr. 6, 2011 (JP) 2011-084830

(51) Int. Cl. H01H 1/10

(52) U.S. Cl. 200/512

(57) ABSTRACT

A touch panel that is used by being superposed on a display panel, the touch panel including: a first electrode substrate including a first substrate and a first conductive film that is formed on the first substrate, the first conductive film including plural conductive areas that are divided into three or more areas along a longitudinal direction and divided into three or more areas along a lateral direction; and a second electrode substrate including a second substrate and a second conductive film that is formed on the second substrate, the second conductive film being opposed to the first conductive film, wherein each of boundary lines of the plural conductive areas forms a predetermined angle with respect to an alignment direction of pixels of the display panel.

### CROSS-REFERENCE TO RELATED APPLICATION

The present application is based upon and claims the benefit of priority of Japanese Patent Application No. 2011-084830, filed on Apr. 6, 2011, the entire contents of which are incorporated herein by reference.

### BACKGROUND OF THE INVENTION

1. Field of the Invention

The present invention relates to a touch panel.

2. Description of the Related Art

A touch panel is an input device by which data input can be performed directly on a display, where the touch panel is placed on the front of the display. Since input can be performed directly to the touch panel based on visually acquired information output from the display, the touch panel is widely used for various purposes.

As to such a touch panel, a resistance film type touch panel is widely known. The resistance film type touch panel includes an upper electrode substrate and a lower electrode substrate each of which is provided with a transparent conductive film, in which the upper electrode substrate and the lower electrode substrate are placed such that the transparent conductive films are opposed to each other. By applying a force on a point of the upper electrode substrate, the transparent conductive films contact with each other at the point so that the position at which the force is applied can be detected.

The resistance film type touch panel can be roughly classified to a 4 wire type and a 5 wire type. In the touch panel of the 4 wire type, an electrode of an X axis is provided on either one of the upper electrode substrate and the lower electrode substrate, and an electrode of a Y axis is provided on another one of the upper electrode substrate and the lower electrode substrate. On the other hand, in the 5 wire type, both of the electrode of the X axis and the electrode of the Y axis are provided on the lower electrode substrate, in which the upper electrode substrate functions as a probe for detecting a voltage (refer to Japanese Laid-Open Patent Application No. 2004-272722 and Japanese Laid-Open Patent Application No. 2008-293129, for example).

In the conventional touch panel, when there are plural contact positions at the same time, respective contact positions cannot be detected.

### SUMMARY OF THE INVENTION

An object of the present invention is to provide a touch panel that can detect respective contact positions even when there are plural contact positions at the same time and that can improve visibility of a screen of a display.

According to an embodiment, there is provided a touch panel that is used by being superposed on a display panel, the touch panel including:

a first electrode substrate including a first substrate and a first conductive film that is formed on the first substrate, the first conductive film including plural conductive areas that are divided into three or more areas along a longitudinal direction and divided into three or more areas along a lateral direction; and

a second electrode substrate including a second substrate and a second conductive film that is formed on the second substrate, the second conductive film being opposed to the first conductive film,

wherein each of boundary lines of the plural conductive areas forms a predetermined angle with respect to an alignment direction of pixels of the display panel.

Other objects, features and advantages of the present invention will become more apparent from the following detailed description when read in conjunction with the accompanying drawings.

### BRIEF DESCRIPTION OF THE DRAWINGS

FIG. 1 is a perspective view of a 5 wire type touch panel;

FIG. 2 is a schematic diagram of a section of the 5 wire type touch panel;

FIGS. 3A and 3B are explanatory schematic diagrams (1) for explaining a coordinate detection method in the 5 wire type touch panel;

FIGS. 4A and 4B are explanatory schematic diagrams (2) for explaining a coordinate detection method in the 5 wire type touch panel;

FIG. 5 is a structural diagram of an upper electrode substrate of an touch panel of an embodiment;

FIG. 6 is a structural diagram of a lower electrode substrate of the touch panel of the embodiment;

FIG. 7 is a section view of the touch panel of the embodiment;

FIG. 8 is an explanatory diagram of the touch panel of the embodiment;

FIG. 9 is an explanatory diagram of conductive areas of the upper electrode substrate of the touch panel of the embodiment;

FIG. 10 is a diagram showing a driving circuit of the touch panel of the embodiment;

FIG. 11 is a diagram showing a timing chart for driving the driving circuit of the touch panel of the embodiment;

FIG. 12 is a diagram showing a modified example of the touch panel of the embodiment;

FIG. 13 is a diagram showing a modified example of the touch panel of the embodiment;

FIG. 14 is a diagram showing a modified example of the touch panel of the embodiment;

FIG. 15 is a diagram showing a modified example of the touch panel of the embodiment;

FIG. 16 is a diagram showing a modified example of the touch panel of the embodiment;

FIG. 17 is a diagram showing a modified example of the touch panel of the embodiment; and

FIGS. 18A and 18B are diagrams showing modified examples of the touch panel of the embodiment.

### DETAILED DESCRIPTION OF THE PREFERRED EMBODIMENTS

Prior to describing an embodiment of the present invention, problems will be described in more detail with reference to figures for convenience of understanding.

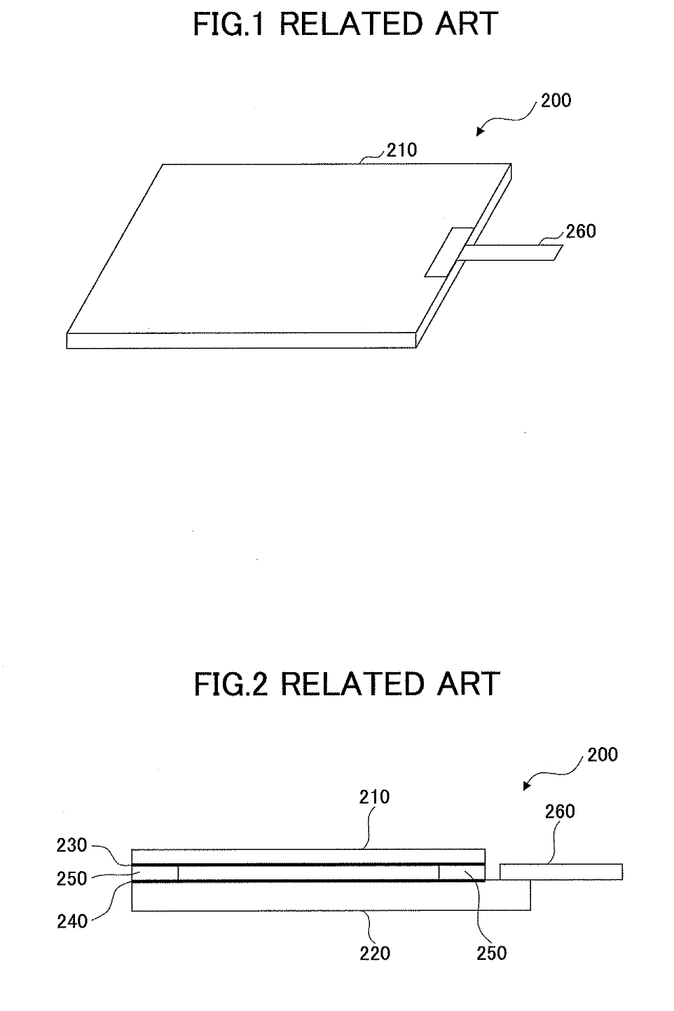

A touch panel of the 5 wire type is described with reference to FIGS. 1 and 2. FIG. 1 is a perspective view of the 5 wire type touch panel. FIG. 2 is a schematic diagram of a section of the 5 wire type touch panel.

The 5 wire type touch panel 200 includes a film 210, which corresponds to an upper electrode substrate, in which a transparent conductive film 230 is formed on one surface, and includes a glass 220, which corresponds to a lower electrode substrate, in which a transparent conductive film 240 is formed on one surface. The film 210 and the glass 220 are placed via a spacer 250 such that the transparent conductive film 230 and the transparent conductive film 240 are opposite with each other. The 5 wire type touch panel 200 is electrically connected to a host computer (not shown in the figure) by a cable 260.

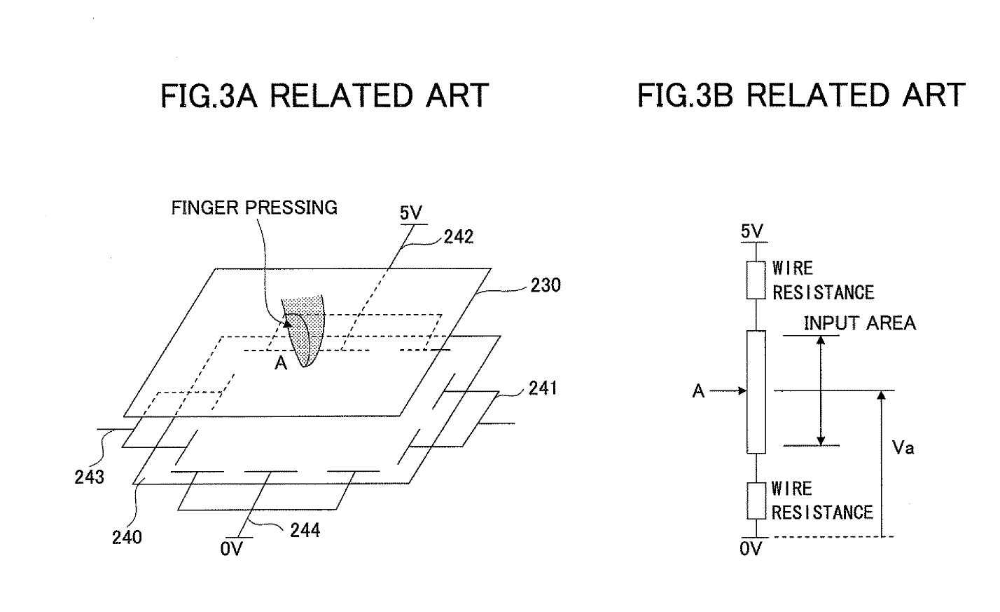

In the 5 wire type touch panel having the above-mentioned configuration, as shown in FIG. 3A, a voltage is applied alternately in the X axis direction and the Y axis direction via electrodes 241, 242, 243 and 244 that are provided at four sides of end parts of the transparent conductive film 240. When the transparent conductive film 230 and the transparent conductive film 240 contact with each other at the contact position (A point), a potential Va is detected via the transparent conductive film 230, so that a coordinate position of each of the X axis and the Y axis is detected as shown in FIG. 3B.

According to the 5 wire type touch panel, although it is possible to detect a contact position at one point, position detection cannot be performed when contact occurs at plural points at the same time.

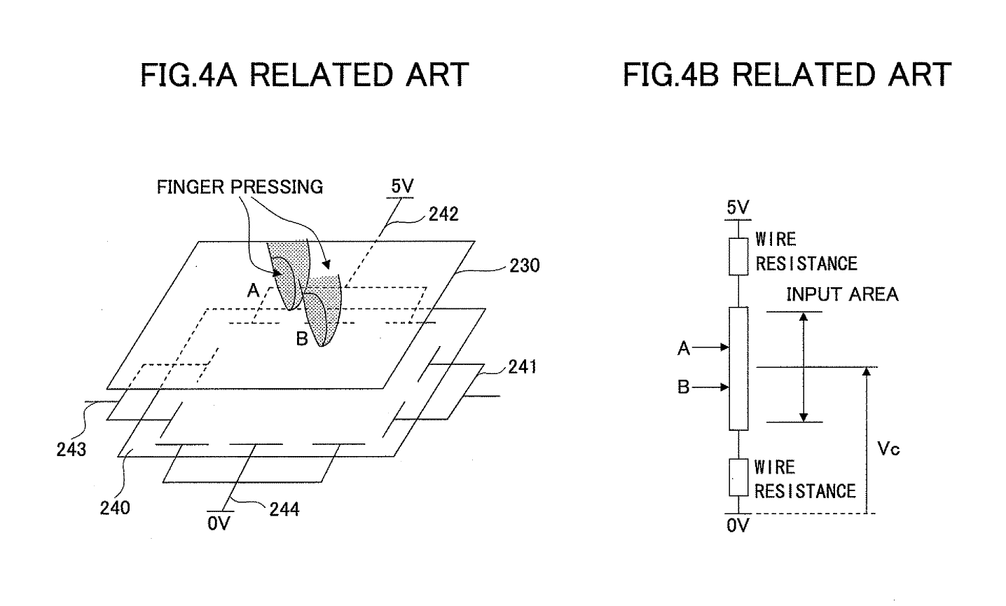

That is, as shown in FIG. 4A, in the case when a voltage is applied alternately in the X axis direction and the Y axis direction by electrodes 241, 242, 243 and 244 that are provided at four sides of the transparent conductive film 240, if the transparent conductive film 230 and the transparent conductive film 240 contact with each other at two points of a contact position A and a contact position B, a coordinate position at the midpoint, that is not pressed, between the A point and the B point is detected. As shown in FIG. 4B, since the position detection method is based on potential detection, even when the transparent conductive films contact with each other at two points of the contact positions A and B, only one potential Vc is detected via the transparent conductive film 230. Thus, it is determined that the contact position is only one point.

According to an embodiment, there is a touch panel in which the transparent conductive film formed on the upper electrode substrate or on the lower electrode substrate is divided into plural areas so as to detect each of plural positions of simultaneous contact. In such a touch panel, if a boundary line between plural areas is oriented in a direction the same as an alignment direction of pixels of the display, the boundary lines are visually shown. Thus, there is a problem in that visibility of the screen of the display panel is deteriorated when the touch panel is implemented by being superposed on the display panel.

In the following, an embodiment of the present invention to solve the above-mentioned problems is described with reference to figures.

### (Outline of Embodiments)

According to an embodiment, there is provided a touch panel that is used by being superposed on a display panel, the touch panel including:

a first electrode substrate including a first substrate and a first conductive film that is formed on the first substrate, the first conductive film including plural conductive areas that are divided into three or more areas (8 areas, for example) along a longitudinal direction and divided into three or more areas (4 areas, for example) along a lateral direction; and

a second electrode substrate including a second substrate and a second conductive film that is formed on the second substrate, the second conductive film being opposed to the first conductive film,

wherein each of boundary lines of the plural conductive areas forms a predetermined angle with respect to an alignment direction of pixels of the display panel.

The first electrode substrate may be placed on a side of the display panel, or the second electrode substrate may be placed on a side of the display panel.

The first substrate may be rectangular in planar view, and each of the boundary lines of the plural conductive areas of the first conductive film is formed so as to form the predetermined angle with respect to an end side of the first substrate.

Each of the boundary lines of the plural conductive areas of the first conductive film may be a boundary line that linearly divides the first conductive film in the longitudinal direction or in the lateral direction obliquely with the predetermined angle with respect to the end side of the first conductive film.

Also, each of the boundary lines of the plural conductive areas of the first conductive film may be a sawtooth line that divides the first conductive film in the longitudinal direction or in the lateral direction.

Also, each of the boundary lines of the plural conductive areas of the first conductive film may be a curved line that divides the first conductive film in the longitudinal direction or in the lateral direction.

In the touch panel, a conductive area of the plural conductive areas that does not contact any of end sides of the first electrode substrate may include a leader part that extends to an end side of the first electrode substrate.

The touch panel may further includes a first connector and a second connector,

the first connector being connected to a first group of conductive areas of the plural conductive areas, and

the second connector being connected to a second group of conductive areas of the plural conductive areas, wherein the second group is not included in the first group, and

wherein the first connector and the second connector are placed at different sides of the first electrode substrate.

The touch panel may further includes:

electrodes that are provided at end parts of four sides of the second conductive film in order to cause a potential distribution on the second conductive film; and

a coordinate detection circuit that is connected to each of the plural conductive areas of the first conductive film and that is configured to detect a coordinate position in a conductive area of the plural conductive areas when the conductive area contacts the second conductive film.

According to an embodiment, it becomes possible to provide a touch panel that can detect respective contact positions even when there are plural contact positions at the same time and that can improve visibility of the screen of the display.

### DETAILED DESCRIPTION OF EMBODIMENTS

In the following, a touch panel of an embodiment is described.

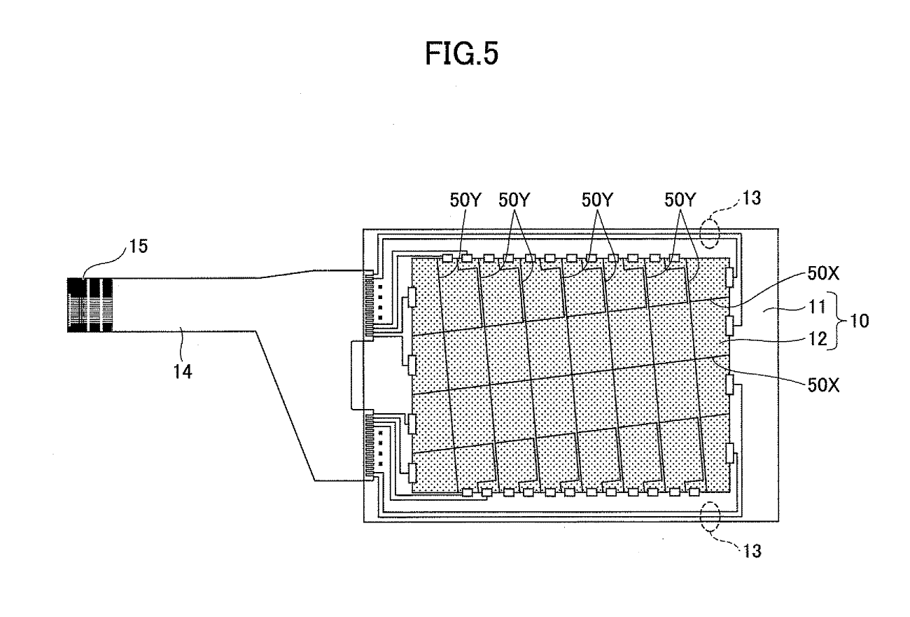

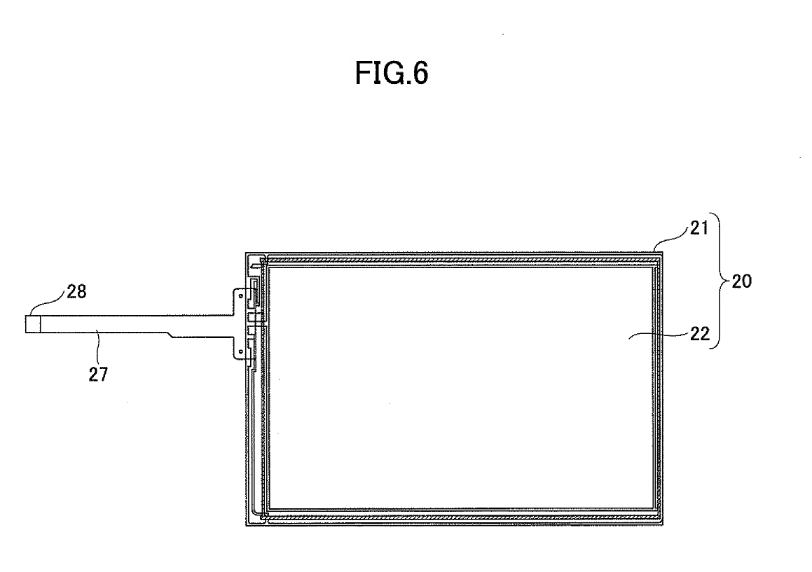

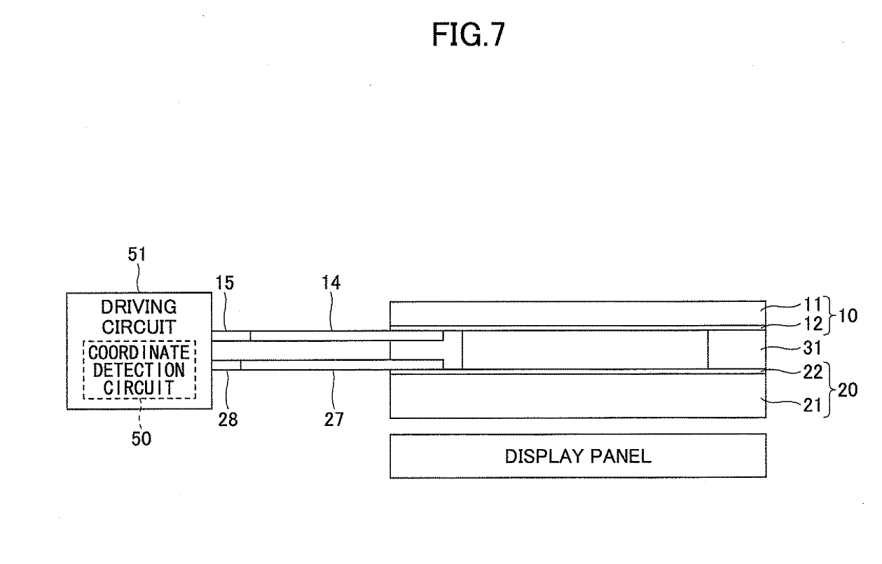

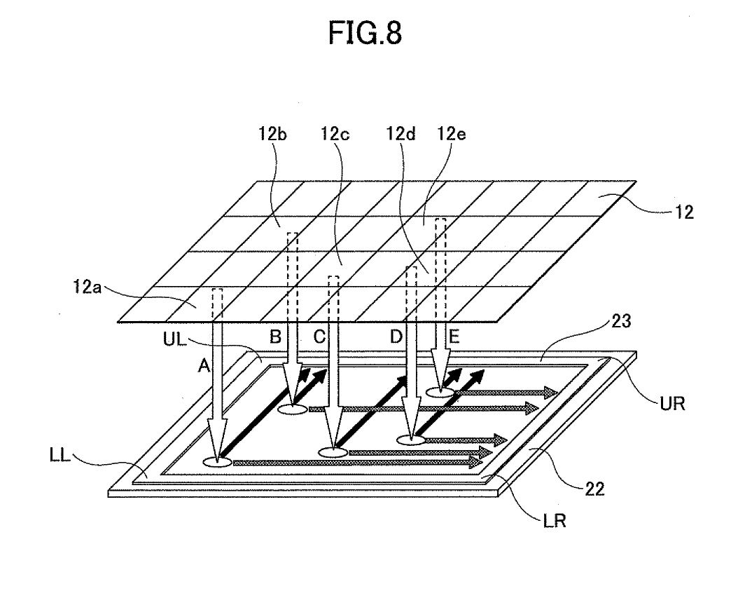

FIG. 5 is a structural diagram of an upper electrode substrate of the touch panel of the present embodiment. FIG. 6 is a structural diagram of a lower electrode substrate of the touch panel of the present embodiment. FIG. 7 is a section view of the touch panel of the present embodiment. FIG. 8 is an explanatory diagram of the touch panel of the present embodiment.

The touch panel of the present embodiment includes an upper electrode substrate 10 and a lower electrode substrate 20. The upper electrode substrate 10 is shaped almost like a rectangle, and the upper electrode substrate 10 includes a film 11 and a transparent electrode film 12, the transparent electrode film 12 being formed on one surface of the film 11. The shape of the lower electrode substrate 20 is almost the same as the shape of the upper electrode substrate 10. The lower electrode substrate 20 includes a glass substrate 21 and a transparent conductive film 22, the transparent conductive film 22 being formed on one surface of the glass substrate 21.

Also, the touch panel includes a driving circuit 51 that includes a coordinate detection circuit 50. The coordinate detection circuit 50 and the driving circuit 51 shown in FIG. 7 are merely examples, and configurations of the coordinate detection circuit 50 and the driving circuit 51 are not limited to those shown in FIG. 7. FIG. 7 shows a display panel as an example.

The upper electrode substrate 10 and the lower electrode substrate 20 are connected via a spacer 31 and the like with an adhesive or a double-stick tape such that the transparent conductive film 12 of the upper electrode substrate 10 and the transparent conductive film 22 of the lower electrode substrate 20 are opposed to each other.

The transparent conductive film 12 of the upper electrode substrate 10 is divided into 4 in a longitudinal direction which is a shorter side direction, and is divided into 8 in a lateral direction which is a longer side direction, so that the transparent conductive film 12 is divided into 32 conductive areas as a whole.

In boundary lines for dividing the transparent conductive film 12 into 32 conductive areas, each of boundary lines extending in the lateral direction is referred to as 50X, and each of boundary lines extending in the longitudinal direction is referred to as 50Y.

In the present embodiment, the boundary lines 50X and 50Y are formed such that each of the boundary lines 50X and 50Y forms a predetermined angle with respect to 4 sides of the film 11. In the present embodiment, the predetermined angle is 20 degrees as an example. It is preferable that the predetermined angle is within a range from about 10 degrees to about 80 degrees.

Dividing into respective conductive areas of the transparent conductive film 12 (forming of boundary lines 50X and 50Y) is performed by removing a part of the transparent conductive film 12 between areas that later become the conductive areas. Accordingly, electrical insulation between divided conductive areas can be realized.

The divided conductive areas of the transparent conductive film 12 are respectively connected to leader electrodes in a leader electrode part 13 provided on both ends in the shorter side direction of the upper electrode substrate 10. Wiring is installed around the upper electrode substrate 10, so that wires are connected to a flexible board (Flexible printed circuits: FPC) 14 at an end part of the longitudinal direction of the upper electrode substrate. A terminal 15 is connected to an end part of the flexible board 14. The terminal 15 is connected to the driving circuit 51 (refer to FIG. 7) including the coordinate detection circuit 50.

Also, as shown in FIG. 8, the lower electrode substrate 20 is provided with a rectangle ring-like electrode 23 on the transparent conductive film 22 in end parts of the 4 sides of the lower electrode substrate 20. The electrode 23 is formed by a resistance film made of Ag or Ag—C. At each of the 4 vertex points LL, LR, UL and UR, a leader (or an extraction line) for controlling the potential of each vertex point is connected. The leader is extracted from the periphery of the lower electrode substrate 20. As shown in FIG. 6, the leader is connected to a flexible board 27 at one end part in the longitudinal direction of the lower electrode substrate 20. In addition, a terminal 28 is connected to the flexible board 27.

Both of the terminal 15 of the flexible board 14 and the terminal 28 of the flexible board 27 are connected to the after-mentioned driving circuit, and are further connected to a host computer (not shown in the figure). A material obtained by adding Al or GA or the like to ITO (Indium Tin Oxide) or ZnO (zinc oxide), a material obtained by adding Sb to SnO₂ (tin oxide), or the like may be used as a material for forming the transparent conductive film 12 and the transparent conductive film 22.

As to the film 11, PET (polyethylene terephthalate), PC (Polycarbonate), or a resin material transparent in visible range can be used. Also, a resin substrate may be used instead of the glass substrate 21.

In the touch panel of the present embodiment, by pressing the upper electrode substrate 10 with a finger and the like, the transparent conductive film 12 of the upper electrode substrate 10 and the transparent conductive film 22 of the lower electrode substrate 20 contact with each other. By detecting a voltage of the position at which the films contact, the contact position of the upper electrode substrate 10 and the lower electrode substrate 20 can be specified, that is, the position at which the upper electrode substrate 10 is pressed with a finger and the like is specified. More specifically, in the upper electrode substrate 10, scanning is performed for each of divided conductive areas of the transparent conductive film 12 in a time division manner so that a conductive area that includes the contact position can be specified based on timing of contact.

By controlling the voltage to be applied to each of the vertex points LL, LR, UL and UR of the rectangle ring-line electrode 23 provided on the transparent conductive film 22 of the lower electrode substrate 20, a voltage is applied in the X axis direction and the Y axis direction alternately.

According to the touch panel in which the transparent conductive film 12 of the upper electrode substrate 10 is divided to form the conductive areas, even though the upper electrode substrate 10 and the lower electrode substrate 20 contact with each other at plural contact positions, the coordinate detection circuit 50 can specify a contact position in each conductive area divided from the transparent conductive film 12. Thus, respective contact positions can be detected independently.

That is, as shown in FIG. 8, even when there are 5 contact positions between the transparent conductive film 12 of the upper electrode substrate 10 and the transparent conductive film 22 of the lower electrode substrate 20 as indicated by arrows A, B, C, D and E, each of the contact positions can be detected independently since conductive areas of the transparent conductive film 12 where the contact positions exist are different with each other.

More specifically, in the case when the contact position between the upper electrode substrate 10 and the lower electrode substrate 20 is the position indicated by the arrow A, a conductive area 12a of the transparent conductive film 12 contacts the transparent conductive film 22. In the case when the contact position between the upper electrode substrate 10 and the lower electrode substrate 20 is the position indicated by the arrow B, a conductive area 12b of the transparent conductive film 12 contacts the transparent conductive film 22. In the case when the contact position between the upper electrode substrate 10 and the lower electrode substrate 20 is the position indicated by the arrow C, a conductive area 12c of the transparent conductive film 12 contacts the transparent conductive film 22. In the case when the contact position between the upper electrode substrate 10 and the lower electrode substrate 20 is the position indicated by the arrow D, a conductive area 12d of the transparent conductive film 12 contacts the transparent conductive film 22. In the case when the contact position between the upper electrode substrate 10 and the lower electrode substrate 20 is the position indicated by the arrow E, a conductive area 12e of the transparent conductive film 12 contacts the transparent conductive film 22. Since the conductive areas 12a, 12b, 12c, 12d and 12e of the transparent conductive film 12 are different areas that are isolated with each other, each of them can be detected independently.

Therefore, even when the number of contact positions between the upper electrode substrate 10 and the lower electrode substrate 20 is 5, each of the contact positions can be specified.

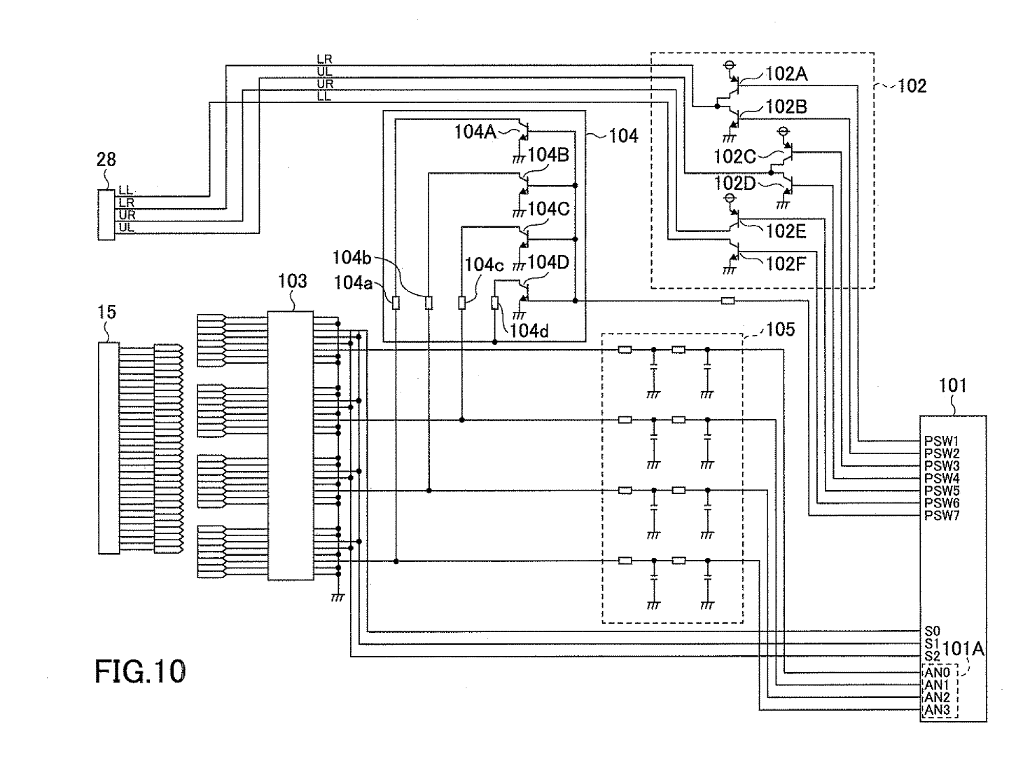

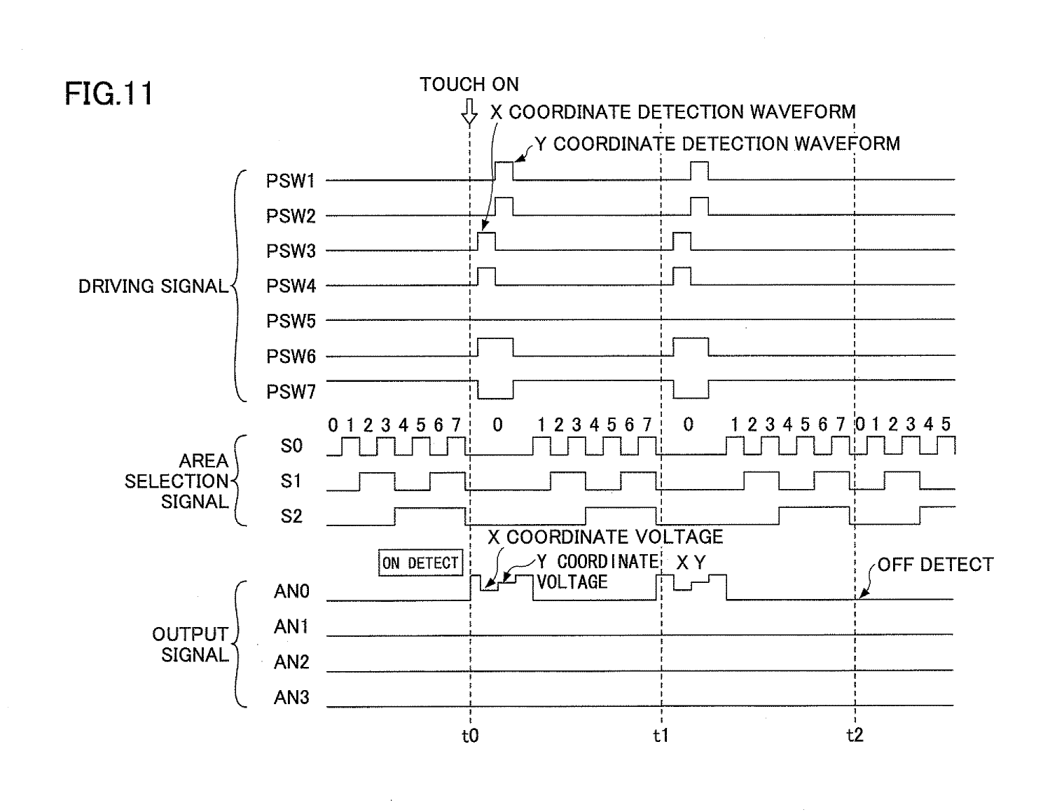

A configuration of a driving circuit that enables the above-mentioned control is described later with reference to FIGS. 10 and 11.

As mentioned above, even when there are plural contact positions between the transparent conductive film 12 and the transparent conductive film 22, each conductive area where contact occurs can be specified. In addition, by detecting potential distribution on the transparent conductive film 22, a coordinate position can be detected more accurately. Also, even when the contact position between the transparent conductive film 12 and the transparent conductive film 22 moves, the move of the contact position can be detected. In addition, by detecting distribution of potential of the transparent conductive film 22, it is possible to detect position coordinates of the moving contact position.

Next, division into the conductive areas of the transparent conductive film 12 in the upper electrode substrate 10 is described.

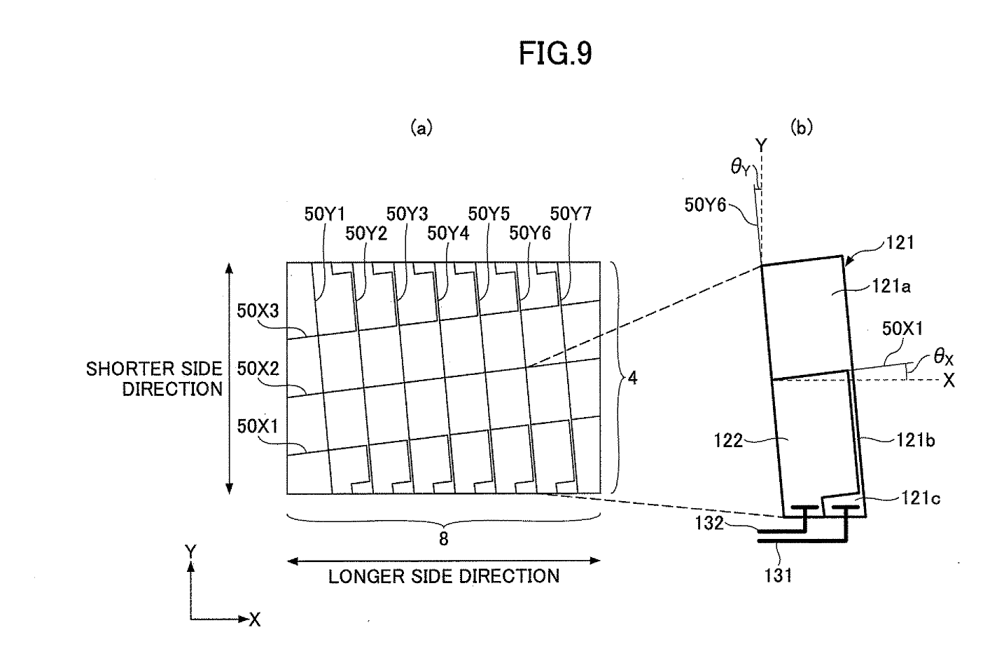

The X axis and the Y axis are defined as shown in FIG. 9. The X axis is an axis that is parallel to an end side of the film 11 extending in the longer side direction of the film 11 (refer to FIG. 5). The Y axis is an axis that is parallel to an end side of the film 11 extending in the shorter side direction of the film 11. Also, directions of the X axis and the Y axis are the same as alignment directions of pixels of a display panel on which the touch panel is implemented.

As shown in the (a) side of FIG. 9, in the present embodiment, the transparent conductive film 12 is divided into 4 areas along the longitudinal direction that is the shorter side direction, and is divided into 8 areas in the lateral direction that is the longer side direction, so that the transparent conductive film 12 is divided into 32 areas.

The 32 conductive areas of the transparent conductive film 12 are divided by 3 boundary lines 50X1˜50X3 and 7 boundary lines 50Y1˜50Y7.

Each of the boundary lines 50X1˜50X3 forms an angle θx of 20 degrees with respect to the X axis, and each of the boundary lines 50Y1˜50Y7 forms an angle θy of 20 degrees with respect to the Y axis.

In the following description, when respective boundary lines 50X1˜50X3 are not distinguished from each other, each of the boundary lines 50X1˜50X3 is referred to as a boundary line 50X, and when respective boundary lines 50Y1˜50Y7 are not distinguished from each other, each of the boundary lines 50Y1˜50Y7 is referred to as a boundary line 50Y.

Accordingly, by forming an angle for the boundary lines 50X, 50Y with respect to the X axis and the Y axis respectively, the boundary lines 50X and 50Y become barely noticeable (become invisible) when the touch panel of the present embodiment is overlapped on the display, so that visibility of the display contents can be improved. In the present embodiment, compared to the case when the boundary lines are placed in the directions the same as the alignment directions of the pixels (that is, the case both of θx and θy are 0), reflection by the boundary lines can be suppressed. Therefore, the boundary lines 50X and 50Y become invisible (unnoticeable).

The 32 divided areas are grouped into 2 upper rows, and 2 lower rows. As illustrated in FIG. 5, the 2 upper rows of conductive areas are connected to the leader electrodes of the leader electrode part 13 at an end part that is an upper end in the shorter direction (longitudinal direction), the 2 lower rows of conductive areas are connected to the leader electrodes of the leader electrode part 13 at another end part that is a lower end in the shorter direction (longitudinal direction).

In this embodiment, the touch panel is designed to be mainly operated by the fingers of the user. For this reason, each of the conductive areas has an approximately rectangular shape or an approximately square shape, and the longer side of the approximately rectangular shape or one side of the approximately square shape of the largest conductive area is preferably 25 mm or less, and more preferably 20 mm or less.

The upper limit of the size of the conductive area may be determined based on the size of the fingers in order to enable multiple contact positions that are pressed simultaneously by the fingers of the user to be detected independently. In other words, if one side of the conductive area is shorter than the distance between two finger tips of the user, it is possible to independently detect multiple contact positions that are pressed simultaneously by the finger tips. Accordingly, the range of the size of one side of the conductive area may be determined based on the interval between finger tips of a human and operability and the like.

On the other hand, if the size of the conductive area is too small, the area occupied by the leader electrode part increases, which may deteriorate the performance of the touch panel. Thus, the shorter side of the approximately rectangular shape or one side of the square shape of the smallest conductive area is preferably 5 mm or greater, and more preferably 7 mm or greater.

Each of the conductive areas of the transparent conductive film 12 is formed by removing a part of the transparent conductive film 12 along the periphery of each conductive area. Accordingly, insulation between adjacent conductive areas can be maintained.

In one method, laser light is irradiated onto the part to be removed, so that the part of the transparent conductive film 12 is removed by heat or abrasion. In another method, a photoresist is coated on the transparent conductive film 12 so that a resist pattern is formed on areas corresponding to the conductive areas by performing exposures and development using an exposure apparatus, and areas of transparent conductive film 12 where no resist pattern is formed are removed by performing dry-etching or wet-etching. In still another method, an etching paste is printed on the part where the transparent conductive film 12 is to be removed so as to remove the part. It is preferable to remove the part of the transparent conductive film 12 by irradiating laser light.

The width of the transparent conductive film 12 to be removed for forming the conductive area is preferably equal to or less than 1 mm. In the touch panel, if the width of the removed area is wide, the function of the touch panel cannot be sufficiently exerted since undetectable areas increase. It is assumed that a finger or a pen touches the touch panel, and the radius of the tip of the pen and the like is about 0.8 mm. Thus, if the width of the removed area of the transparent conductive film 12 is less than 1 mm, the removed area does not cause trouble for the function of the touch panel. In the present embodiment, in order to increase visibility and to improve the performance, the width of the area where the transparent conductive film 12 is removed is about 100 μm.

In the transparent conductive film 12 of the upper electrode substrate 10 of the touch panel of the present embodiment, the conductive areas of the transparent conductive film 12 in the upper rows are arranged with a pattern that is inverted from the pattern with which the conductive areas (including the conductive area 121 and the conductive area 122) in the lower rows are arranged.

Also, 8 columns are arranged in the lateral direction, each column including a pattern that includes 4 conductive areas arranged in the longitudinal direction.

The side (b) of FIG. 9 shows an enlarged figure of conductive areas of lower 2 rows shown in the side (a) of FIG. 9, where one conductive area is indicated as 121 and another is indicated as 122. As illustrated in the side (b) of FIG. 9, the conductive area 122 contacts one of the longer sides (that is, the lower side) of the upper electrode substrate 10. On the other hand, the conductive area 122 does not contact any of the longer sides of the upper electrode substrate 10.

Thus, the conductive area 121 has an area part 121a, and a leader part 121b which extends from the area part 121a toward the longer side of the upper electrode substrate 10. Also, a contact part 121c is formed that connects the leader part 121b to one of the longer sides (that is, the lower side) of the upper electrode substrate 10. As shown in the figure, the leader part 121b is formed along one side (that is, the left side) of the conductive area 122, in other words, the leader part 121b is formed between conductive areas that contact the longer side of the upper electrode substrate 10. That is, the leader part 121b is formed between the conductive area 122 and a conductive area that contacts a side adjacent to the conductive area 122. That is, the leader part 121b is formed in an area of the conductive area 122 essentially. Thus, in order to prevent an erroneous position detection, the leader part 121b is preferably narrow as much as possible along the longitudinal direction of the upper electrode substrate 10.

The conductive area 121 connects to a leader electrode 131 at the contact part 121c, and the conductive area 122 connects to a leader electrode 132 near an end part of the conductive area 122 at the longer side of the upper electrode substrate 10.

The contact part 121c of the conductive area 121 is connected to the leader electrode 131 by applying silver paste on the contact part 121c. Similarly, the conductive area 122 is connected to the leader electrode 132 by applying silver paste on the conductive area 122 in a vicinity of one of the longer side (that is, the lower side) of the upper electrode substrate 10. A plurality of such leader electrodes 131 and 132 form the leader electrode part 13 illustrated in FIG. 5.

FIG. 10 is a diagram showing the driving circuit of the touch panel of the present embodiment.

The driving circuit 100 of the touch panel of the present embodiment includes a Micro Control Unit (MCU) 101, a potential control part 102, a multiplexer 103, an output adjusting circuit 104, and a noise filter 105.

The MCU 101 drives and controls the potential control part 102 and the multiplexer 103, and processes coordinate signals representing coordinates of the contact position where the upper electrode substrate 10 is pressed in order to detect coordinates of the contact position. The MCU 101 includes an analog-to-digital converter (ADC) 101A that processes signals representing coordinates obtained from each of the 32 conductive areas of the transparent conductive film 12.

The potential control part 102 includes 6 transistors 102A through 102F. The potential control part 102 controls the voltages to be applied to the vertex parts LL, LR, UL and UR of the rectangular ring-like electrode 23 that is provided on the transparent conductive layer 22 of the lower electrode substrate 20, in order to alternately generate a potential distribution along the X axis direction and the Y axis direction on the lower electrode substrate 20.

The transistors 102A, 102C and 102E are formed by P-type transistors, and the transistors 102B, 102D and 102F are formed by N-type transistors. A power supply voltage (for example, 5 V) is applied to an emitter of the transistor 102A, and an emitter of the transistor 102B is grounded. The driving signals PSW1 and PSW2 output from the MCU 101 are respectively input to bases of the transistors 102A and 102B. In addition, collectors of the transistors 102A and 102B are connected, and a node connecting the collectors is connected to the vertex part LR.

A power supply voltage (for example, 5 V) is applied to an emitter of the transistor 102C, and an emitter of the transistor 102D is grounded. The driving signals PSW3 and PSW4 output from the MCU 101 are respectively input to bases of the transistors 102C and 102D. In addition, collectors of the transistors 102C and 102D are connected, and a node connecting them is connected to the vertex part UL.

A power supply voltage (for example, 5 V) is applied to an emitter of the transistor 102E, and the driving signal PSW5 output from the MCU 101 is input to a base of the transistor 102E. A collector of the transistor 102E is connected to the vertex part UR.

An emitter of the transistor 102F is grounded, and the driving signal PSW6 output from the MCU 101 is input to a base of the transistor 102F. A collector of the transistor 102F is connected to the vertex part LL.

The potential control part 102 alternately generates a potential distribution along the X axis direction and the Y axis direction on the lower electrode substrate 20 based on the driving signals PSW1 through PSW6 input from the MCU 101.

The multiplexer 103 is connected to each of the conductive areas of the transparent conductive film 12, where the transparent conductive film 12 is divided into 32 by 4 rows×8 columns as shown in FIG. 8. The multiplexer 103 scans the conductive areas of the transparent conductive film 12, one column at a time, and detects a signal representing a potential distribution of the conductive areas. The scan is performed based on area selection signals S0, S1 and S2 that are output from the MCU 101. The area selection signals S0, S1 and S2 are signals for selecting each of the 8 areas one by one arranged in the column direction in each row. According to the area selection signals S0, S1 and S2, each of the areas is selected in order in the column direction in a row. The selection is performed for 4 rows at a time. Output signals AN0 through AN3 representing the potential distribution for each row are input to the ADC 101A of the MCU 101 wherein the xy coordinates are detected.

The output adjusting circuit 104 is connected to each of signal lines for outputting the output signals AN0 through AN3 of each row of the multiplexer 103 to the MCU 101, and includes adjusting resistors 104a through 140d and switching elements 104A through 104D. A driving signal PSW7 from the MCU 101 is input to bases of the switching elements 104A through 104D. The switching elements 104A through 104D are configured such that the PSW0 signal output from the MCU 101 is input to the base. The switching elements 104A through 1040 are initially ON before the upper electrode substrate 10 of the touch panel is pressed (touched), in order to initially maintain the potential of the transparent conductive film 22 of the lower electrode substrate 20 to a predetermined potential (for example, 0 V). When the upper electrode substrate 10 of the touch panel is pressed, the switching elements 104A through 104D are turned OFF in order to hold potentials of respective signal lines in a potential.

In the case where conductive areas of the transparent conductive film 12 of the upper electrode substrate 10 have the configuration illustrated in the right part of FIG. 9, for example, the resistance of the 16 conductive areas in the 2 central rows (2 inside rows in the shorter side direction) is larger than the resistance of the 16 conductive areas in the upper and lower rows (2 outside rows in the shorter direction). Thus, a delay occurs in the detection of potential change for contact in the 16 conductive areas of the two central rows because of the difference in the resistances. Accordingly, the resistances of the adjusting resistors 104b and 104c that are connected to the 2 central rows are adjusted to be smaller than the resistances of the adjusting resistors 104a and 104d that are connected to the upper and lower rows. The output adjusting circuit 104 thus eliminates the difference in the response speed of detecting the contact position, between the conductive areas in the 2 central rows and the conductive areas in the upper and lower rows.

The noise filter 105 is formed by an RC filter circuit, that is connected to each of signal lines for outputting the output signals AN0 through AN3 of each row of the multiplexer 103 to the MCU 101 and that eliminates noise included in the output signals AN0 through AN3. The output signals AN0 through AN3 that have passed through the noise filter 105 are input to the analog-to-digital filter 101A included in the MCU 101.

FIG. 11 is a diagram showing a timing chart for driving the driving circuit of the touch panel. It is assumed for the sake of convenience that the upper electrode substrate 10 is pressed to cause contact of the transparent conductive films 12 and 22 at a time t0 and at a time t1.

In a state before the time t0, all of the driving signals PSW1 through PSW6 have a low level. Hence, the potentials at the vertex parts LR, UL and UR of the electrode 23 is 5 V, and the vertex part LL is at a floating potential (open).

In this state, the driving signal PSW7 has a high level, and all of the switching elements 104A through 104D of the output adjusting circuit 104 are ON. Hence, all of the output signals AN0 through AN3 have a low level (0 V) and indicate that no touch is performed.

The area selection signals S0 through S2 to be output from the MCU 101 are driven as shown in FIG. 11, so that the 8 areas are selected one by one by the multiplexer 103 for each row, and the output signals AN0 through AN3 are input to the MCU 101. The conductive area (0) (to be also referred to as conductive area in the column number 0) is selected when the area selection signals S0 through S2 are S0=L, S1=L, S2=L, where “L” denotes the low signal level. The conductive area in the column number 1 is selected when the area selection signals S0 through S2 are S0=H, S1=L, S2=L, where “H” denotes the high signal level. Similarly, the conductive area in the column number 2 is selected when the area selection signals S0 through S2 are S0=L, S1=H, S2=L, the conductive area in the column number 3 is selected when the area selection signals S0 through S2 are S0=H, S1=H, S2=L, the conductive area in the column number 4 is selected when the area selection signals S0 through S2 are S0=L, S1=L, S2=H, the conductive area in the column number 5 is selected when the area selection signals S0 through S2 are S0=H, S1=L, S2=H, the conductive area in the column number 6 is selected when the area selection signals S0 through S2 are S0=L, S1=H, S2=H, and the conductive area in the column number 7 is selected when the area selection signals S0 through S2 are S0=H, S1=H, S2=H. The selection is performed for 4 rows at a time.

It is assumed that, at the time t0, a touch occurs in a conductive area of the 32 conductive areas. In this embodiment, it is assumed that a 0-th conductive area in a row corresponding to the output signal AN0 is pressed. For example, this 0-th conductive area in the row corresponding to the output signal AN0 is the conductive area located at the upper left (UL) corner of the touch panel shown in FIG. 9.

When the potential of the output signal AN0 rises at the time t0, the driving signals PSW3, PSW4 and PSW6 rise to the high level in order to detect the X coordinate, and consequently, the potential distribution in the X axis direction is generated on the transparent conductive film 22 of the lower electrode substrate 20. In this state, the driving signal PSW7 has the low level, and the switching elements 104A through 104D of the output adjusting circuit 104 are OFF.

Thereafter, the driving signals PSW3 and PSW4 fall to the low level and the driving signals PSW1 and PSW2 rise to the high level, in order to detect the Y coordinate.

At the time t0, the transparent conductive film 12 of the upper electrode substrate 10 is pressed and contacts the transparent conductive film 22 of the lower electrode substrate 20. For this reason, a potential corresponding to the X coordinate and the Y coordinate of the contact position is generated in the transparent conductive film 12 of the upper electrode substrate 10, and the potential is output as the output signal AN0.

The output signal AN0 is input to the MCU 101, and the XY coordinates of the contact position is converted into the digital signal by the ADC 101A in the MCU 101.

When the detection of the XY coordinates ends, the switching signals PSW1, PSW2 and PSW6 return to the low level. As a result, preparations for detecting an output signal from the conductive area (1) become completed. The detection of the XY coordinates is performed in a similar manner when the contact position occurs within the same area at the time t1. Of course, the contact position occurring within other conductive areas of the transparent conductive film 12 may be detected in a manner similar to that described above.

The 32 conductive areas of the transparent conductive film 12 are insulated from each other as described above, and the output signals from the conductive areas are successively selected and output from the multiplexer 103 for each of the conductive areas. Accordingly, the coordinate detection can be made separately and independently for each of the 32 conductive areas in the 8 columns (column numbers 0 through 7), based on the output signals AN0 through AN3 corresponding to the 4 rows.

According to the touch panel of the present embodiment, scanning is performed for the divided conductive areas of the transparent conductive film 12 on the upper electrode substrate 10 in a time division manner, so that any conductive area including a contact position can be detected based on scanning timing.

Also, by dividing the transparent conductive film 12 of the upper electrode substrate 10 to form the conductive areas, even when the upper electrode substrate 10 and the lower electrode substrate 20 contact at plural contact positions, the contact positions can be detected for each of the conductive areas of the transparent conductive film 12.

Therefore, even when the touch panel is touched at plural positions, each of the positions can be detected independently.

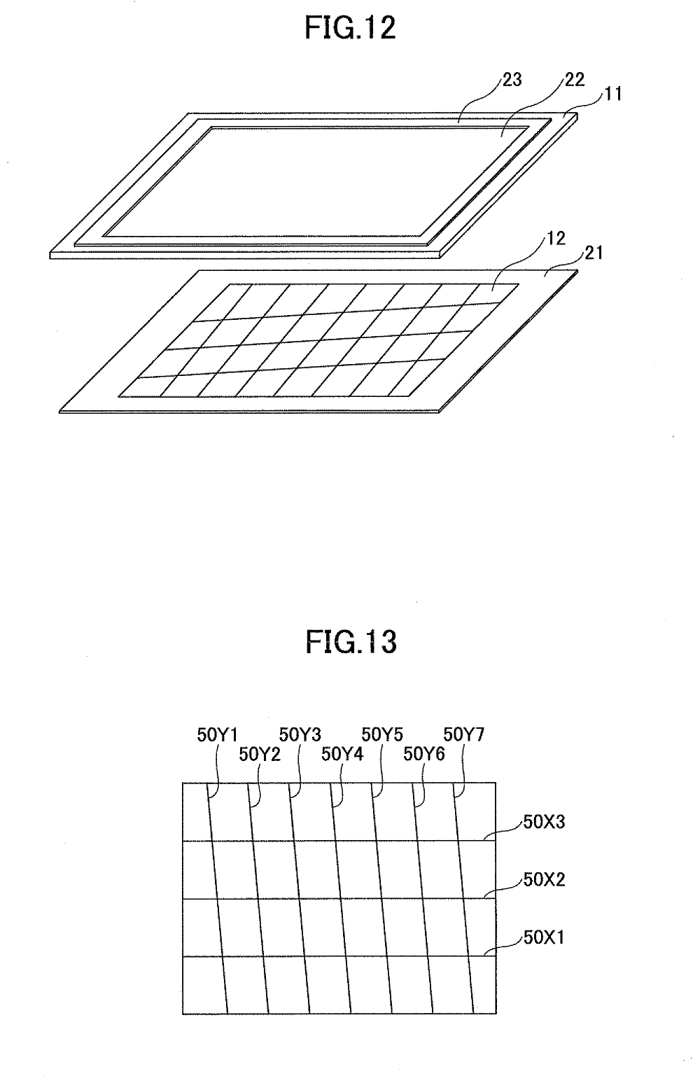

Next, modified examples of the touch panel of the present embodiment are described with reference to FIGS. 12-18.

In the embodiment described so far, the transparent conductive film 12 is formed on the film 11, and the transparent conductive film 22 and the electrode 23 are formed on the glass substrate 21. But, as shown in FIG. 12, the transparent conductive film 22 and the electrode 23 may be formed on the film and the transparent conductive film 12 may be formed on the glass substrate 12.

In this case, the potential distribution is caused on the film 11 so that the contact position is detected in the glass substrate 21 side. Also in this example, similarly to the previously mentioned embodiment, detection of plural positions can be performed.

Also, in this case, since the boundary lines 50X and 50Y (refer to FIG. 9) are formed in the side of the glass substrate 21, the boundary lines 50X and 50Y are less noticeable for a user who performs operation by viewing the display from the side of the film 11.

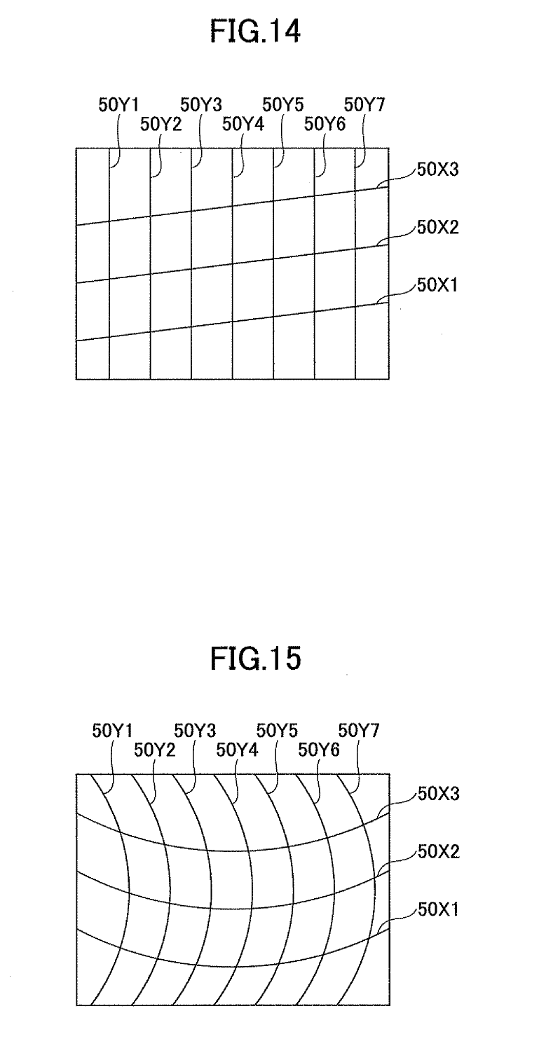

In the previously-mentioned embodiment, the boundary lines 50X1˜50X3 form an angle with respect to the X axis, and the boundary lines 50Y1˜50Y7 form an angle with respect to the Y axis. But, as shown in FIG. 13, only the boundary lines 50Y1˜50Y7 may form an angle with respect to the Y axis. Similarly, only the boundary lines 50X1˜50X3 may form an angle with respect to the X axis as shown in FIG. 14.

In these cases, at least one of boundary lines of the X axis direction and the Y axis direction can be made unnoticeable.

In the previously-mentioned embodiment, each of the boundary lines 50X1˜50X3 and the boundary lines 50Y1˜50Y7 is a straight line. But, as shown in FIG. 15, the boundary line may be formed as a curved line. By forming each of the boundary lines 50X1˜50×3 and 50Y1˜50Y7 as a curved line, each boundary line forms an angle with respect to an end side of the film 11.

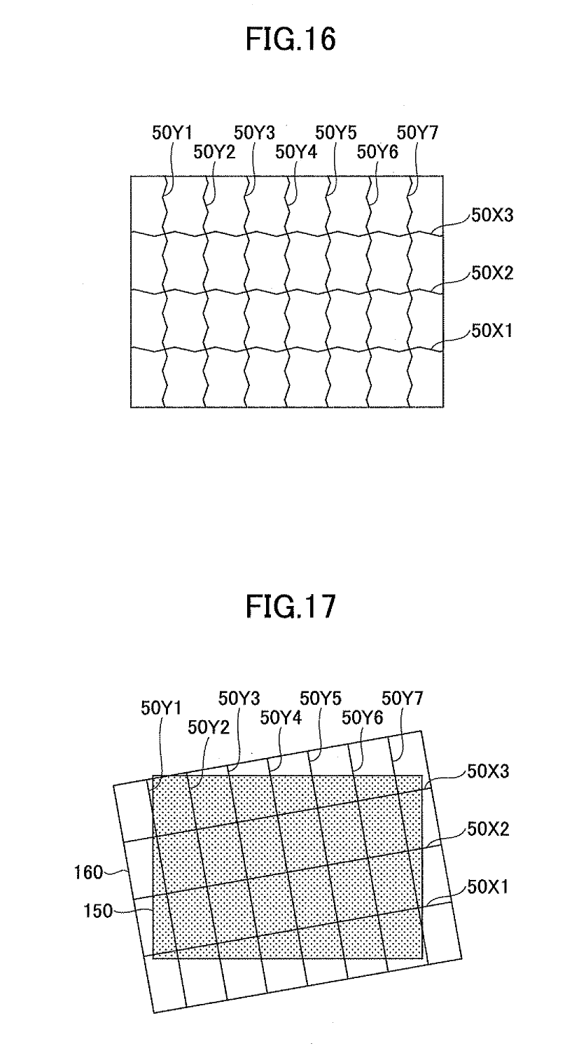

Also, each of the boundary lines 50X1˜50X3 and the boundary lines 50Y1˜50Y7 may be formed like a sawtooth shape as shown in FIG. 16.

Also, as shown in FIG. 17, the touch panel 160 may be implemented such that both of the angles θx and θy formed by the boundary lines 50X1˜50X3 and 50Y1˜50Y7 with respect to the X axis and the Y axis are 0, and that the boundary lines 50X1˜50X3 and 50Y1˜50Y7 form an angle with respect to the display 150.

By attaching the touch panel in which both of the angles θx and θy are 0 to the display 150 with an angle, the boundary lines 50X and 50Y form an angle with respect to the alignment direction of pixels of the display 150. Thus, the boundary lines 50X and 50Y can be made unnoticeable.

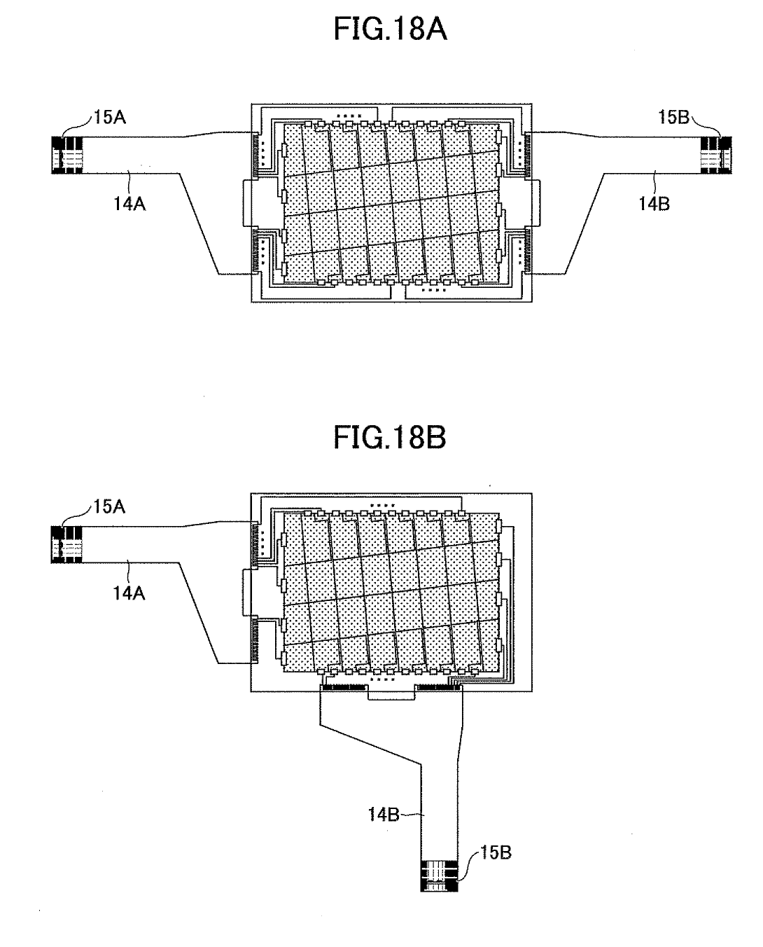

In the configuration of FIG. 5, the flexible board 14 is connected to an end part of the upper electrode substrate 10 in the longer side direction, and the terminal 15 is provided at an end part of the flexible substrate 14. The configuration of the flexible substrate 14 and the terminal 15 may be modified as shown in FIGS. 18A and 18B.

In the upper electrode substrate 10 of the touch panel shown in FIG. 18A, flexible boards 14A and 14B are connected to both sides of the longer side direction of the upper electrode substrate 10 respectively, and wiring is installed such that the leader electrode part 13 are distributed to the flexible substrates 14A and 14B. In the end part of the flexible boards 14A and 14B, terminals 15A and 15B are provided respectively.

In the upper electrode substrate 10 of the touch panel shown in FIG. 18B, flexible boards 14A and 14B are connected to an end side of the longer side direction of the upper electrode substrate 10 and to an end side of the shorter side direction of the upper electrode substrate 10 respectively, and wiring is installed such that the leader electrode parts 13 are distributed to the flexible substrates 14A and 14B. In the end parts of the flexible boards 14A and 14B, terminals 15A and 15B are provided respectively.

As shown in FIGS. 18A and 18B, the flexible boards 14A and 14B and the terminals 15A and 15B are drawn from different end parts of the upper electrode boards 10. By configuring the touch panel like this, even when the number of the conductive areas is large and the number of the leader electrode parts 13 is large, wiring of the leader electrode parts 13 can be easily performed. Also, even when there is a limitation for positions of connection destinations of the terminals 15A and 15B, the terminals 15A and 15B can be easily connected to the connection destinations.

The touch panel described in the present embodiments are merely examples. The present invention is not limited to these embodiments, but various variations and modifications may be made without departing from the scope of the present invention.

What is claimed is:

1. A touch panel that is used by being superposed on a display panel, the touch panel comprising:
a first electrode substrate including a first substrate and a first conductive film that is formed on the first substrate, the first conductive film including plural conductive areas that are divided into three or more areas along a longitudinal direction and divided into three or more areas along a lateral direction; and
a second electrode substrate including a second substrate and a second conductive film that is formed on the second substrate, the second conductive film being opposed to the first conductive film,
wherein each of boundary lines of the plural conductive areas forms a predetermined angle with respect to an alignment direction of pixels of the display panel.

2. The touch panel as claimed in claim 1, wherein the first electrode substrate is placed on a side of the display panel.

3. The touch panel as claimed in claim 1, wherein the second electrode substrate is placed on a side of the display panel.

4. The touch panel as claimed in claim 1, wherein the first substrate is rectangular in planar view, and each of the boundary lines of the plural conductive areas of the first conductive film is formed so as to form the predetermined angle with respect to an end side of the first substrate.

5. The touch panel as claimed in claim 4, wherein each of the boundary lines of the plural conductive areas of the first conductive film is a boundary line that linearly divides the first conductive film in the longitudinal direction or in the lateral direction obliquely with the predetermined angle with respect to the end side of the first conductive film.

6. The touch panel as claimed in claim 4, wherein each of the boundary lines of the plural conductive areas of the first conductive film is a sawtooth line that divides the first conductive film in the longitudinal direction or in the lateral direction.

7. The touch panel as claimed in claim 4, wherein each of the boundary lines of the plural conductive areas of the first conductive film is a curved line that divides the first conductive film in the longitudinal direction or in the lateral direction.

8. The touch panel as claimed in claim 1, wherein a conductive area of the plural conductive areas that does not contact any of end sides of the first electrode substrate includes a leader part that extends to an end side of the first electrode substrate.

9. The touch panel as claimed in claim 1,
the touch panel further comprising a first connector and a second connector,
the first connector being connected to a first group of conductive areas of the plural conductive areas, and
the second connector being connected to a second group of conductive areas of the plural conductive areas, wherein the second group is not included in the first group, and
wherein the first connector and the second connector are placed at different sides of the first electrode substrate.

10. The touch panel as claimed in claim 1, further comprising:
electrodes that are provided at end parts of four sides of the second conductive film in order to cause a potential distribution on the second conductive film; and
a coordinate detection circuit that is connected to each of the plural conductive areas of the first conductive film and that is configured to detect a coordinate position in a conductive area of the plural conductive areas when the conductive area contacts the second conductive film.
